(19) United States
(12) Patent Application Publication
(10) Pub. No.: US 2015/0220158 A1
(43) Pub. Date: Aug. 6, 2015

(54) Methods and Apparatus for Mapping of Arbitrary Human Motion Within an Arbitrary Space Bounded by a User's Range of Motion

(71) Applicant: Nod Inc., Santa Clara, CA (US)

(72) Inventors: Anusankar Elangovan, San Francisco, CA (US); Harsh Menon, Cupertino, CA (US)

(21) Appl. No.: 14/591,877

(22) Filed: Jan. 7, 2015

Related U.S. Application Data
(60) Provisional application No. 61/924,669, filed on Jan. 7, 2014.

(51) Int. Cl. G06F 3/01; G06F 3/0481

(52) U.S. Cl. CPC G06F 3/017; G06F 3/04815

(57) ABSTRACT

Described are apparatus and methods for reconstructing a partial skeletal pose by aggregating various data from various sensors.

In particular are described methods and apparatus for mapping of arbitrary human motion within an arbitrary space bounded by a user's range of motion.

In particular embodiments, methods and apparatus are described for projecting arbitrary human motion in a 3-dimensional coordinate space into a 2-dimensional plane to enable interacting with 2-dimensional user interfaces.

### RELATED APPLICATIONS

This application claims priority to U.S. Provisional Patent Application Ser. No. 61/924,669 filed Jan. 7, 2014, and is hereby incorporated by reference.

### FIELD OF THE ART

This disclosure relates to mapping of arbitrary human motion within an arbitrary space bounded by a user's range of motion.

### BACKGROUND

Many conventional positional depth sensors use camera-based 3D technology and the associated post-processing required in such conventional depth sensing technologies can be substantial. Such technologies, while adequate for certain purposes, have problems, including field-of-view issues, occlusion and poor performance in outdoor and brightly light areas.

### SUMMARY

Described are apparatus and methods for reconstructing a partial skeletal pose by aggregating various data from various sensors.

In particular are described methods and apparatus for mapping of arbitrary human motion within an arbitrary space bounded by a user's range of motion.

In particular embodiments, methods and apparatus are described for projecting arbitrary human motion in a 3-dimensional coordinate space into a 2-dimensional plane to enable interacting with 2-dimensional user interfaces.

In a specific implementation, there is described the specific use case of mapping of a 3D keyboard onto a 2D interface.

### BRIEF DESCRIPTION OF THE DRAWINGS

FIG. 1(A) illustrates the skeletal rendering of the human with various nodes, and the usage of many different sensors according to the embodiments.

FIG. 1(B)1 illustrates a system diagram according to an embodiment.

FIG. 1(B)2 illustrates a system diagram according to another embodiments.

FIG. 2 illustrates that the system allows for the sensor being used for different gesture when pointing at different devices.

FIGS. 3, 4, and 5 show embodiments for micro-gesture recognition according to the embodiments.

FIG. 6 shows an illustration of micro-gestures detected within a subspace that has its own relative coordinate system.

FIG. 7 illustrates a 3D exterior view of a single ring sensor.

FIG. 8 illustrates a more detailed view of the ring sensor of FIG. 7.

FIG. 9 illustrates a computer sensor & receiver according to the embodiments.

FIG. 10 illustrates conversion of a 3D space to a 2D dimension according to embodiments.

FIGS. 11(a)-(b) and 12 illustrate flow charts for the 3D space to 2D dimension conversion according to embodiments.

FIG. 13(a)-(b) illustrate a keyboard implementation according to embodiments.

### DETAILED DESCRIPTION OF THE PREFERRED EMBODIMENT

Various devices such as computers, televisions, electronic devices and portable handheld devices can be controlled by input devices such as a computer mouse or keyboard. Various sensors such as accelerometers, gyroscopes, compasses and cameras can be collectively used (all from a substantially single point such as if disposed on a single ring; or in a head mounted device, or in a capsule either directly mounted on the body or enclosed in a garment or clothing, or from multiple different locations) to estimate and/or derive a gesture or hand movement made with the arm and hand, in order to allow for mapping of arbitrary human motion within an arbitrary space bounded by a user's range of motion, and specifically for interacting with a 2D interface, as well as for mapping to and interacting with a 3D user interface such as a holograph or some other 3D display, drawing or manufacturing interface. These sensors dynamically provide data for varying periods of time when located in the associated space for sensing, and preferably stop or go into a low power mode when not in the associated space. When sensor data is only partially available or is unavailable, various calculations may be employed to reconstruct the skeletal structure without all the sensor data.

Various poses and gestures of the human skeleton over a period of time can be aggregated to derive information that is interpreted (either at the sensor or at the device) and communicated over wireless channels such as WiFi, Bluetooth or Infrared to control various devices such as computers, televisions, portable devices and other electronic devices, as described further herein and in the previously filed U.S. patent application Ser. No. 14/487,039 filed Sep. 14, 2014, which claims priority to U.S. Provisional Application No. 61/877,933 filed Sep. 13, 2013 and entitled “Methods and Apparatus for using the Human Body as an Input Device”, which are explicitly incorporated herein by reference.

Described are apparatus and methods specifically for mapping of arbitrary human motion within an arbitrary space bounded by a user's range of motion, and, in specific embodiments, for projecting arbitrary human gestures/hand movements in a 3-dimensional coordinate space into a 2-dimensional plane to enable interacting with 2-dimensional user interfaces, as well as for mapping to and interacting with a 3D user interface such as a virtual reality scene, a holograph or some other 3D display, drawing/manufacturing interface.

In a preferred embodiment the partial skeletal pose related to the gesture/hand movement is reconstructed by aggregating various data from various sensors. These sensors are preferably worn on the finger, hand (front or palm), wrist or forearm or in a head mounted device, or in a capsule either directly mounted on the body or enclosed in a garment or clothing or combinations of these including all of the human body, though can also be in the immediate environment such as a 3D depth sensor attached to a computer or television.

In a preferred embodiment, MEMS sensors, and preferably a plurality of them within a substantially single location such as on a ring worn on a finger of a human hand, the front or palm of the hand, the wrist of a human arm, the arm, or combinations of these, are used. MEMS sensors provide the advantage of not requiring a separate detector compared to conventional camera based depth sensors. A plurality of MEMS sensors can be used to obtain further information than would be possible with a single such sensor, as described herein. When further used in combination with accelerometers, gyroscopes, compasses, the data from the various sensors can be fused, in one embodiment including human skeletal constraints as described further herein and in the previously filed U.S. patent application Ser. No. 14/487,039 filed Sep. 14, 2014 and entitled “Methods and Apparatus for using the Human Body as an Input Device” referred to above and interpreted to allow for sensing of micro-gestures, as described herein.

Processing of all the data generated to accurately detect the pose of a portion of the human body in real-time and in 3D includes engineering desiderata of event stream interpretation and device power management, as well as usage of algorithms such as Kalman filtering, complementary filters and other conventional algorithms used to fuse the sensor data into coherent pose estimates. The filtering algorithms used are based on the locality of the sensor and factor in the human anatomy and the joint angles of the bones the sensors are tracking. The fused data is then processed to extract micro-gestures—small movements in the human body which could signal an intent, as described further herein.

As described, the user wearing the input platform makes gestures/hand movements in three dimensions that are:

a) arbitrary, in that they are not constrained in any form within the area bounded by the user's range of motion, also referred to as reach;

b) preferentially extracted/pinpointed over the surrounding “noise” that exists in 3D including noise from gestures due to the fingers/hand/arm constantly moving in a way that has nothing to do with the gesture being made.

c) fully mapped, i.e., coordinates are determined and refreshed continuously

Further, in certain embodiments where user interaction is with a 2D interface, the 3D coordinates are instantaneously converted to 2D via projection onto an imaginary plane. This involves projection of human skeletal motion, which is predominantly rotational onto a flat plane as described and shown further herein. Simultaneously, the coordinates are sized proportional to the dimensions of the plane, i.e., they can be projected onto a small surface such as a smartphone or a large surface such as a television, as will be described in more detail below.

A typical application where user interaction is with a 2D interface is for interaction with devices such as computer monitors, tablets, smartphones, televisions, etc. The user can make hand gestures in 3D that project onto the user interface in 2D and can be used to exercise different types of device control such as:

a) replacing the function of a mouse—navigating to an icon/object and clicking on it, scrolling, etc.

b) replacing the function of a keyboard—by utilizing an on-screen virtual keyboard and remotely interacting with the same

c) replacing the touch function on a touch-enabled device such as a tablet or a smartphone—swiping through screens, clicking on icons, interacting with apps, etc.

d) replacing the input device for a smart TV or a TV connected to a set-top box—by entering text remotely (using an on-screen virtual keyboard), swiping through images, entertainment choices, etc.

e) Adding body presence in Virtual Reality or Augmented Reality applications

The above list is only a representative set of use cases; there are many other possibilities, where the basic premise applies, and is applicable.

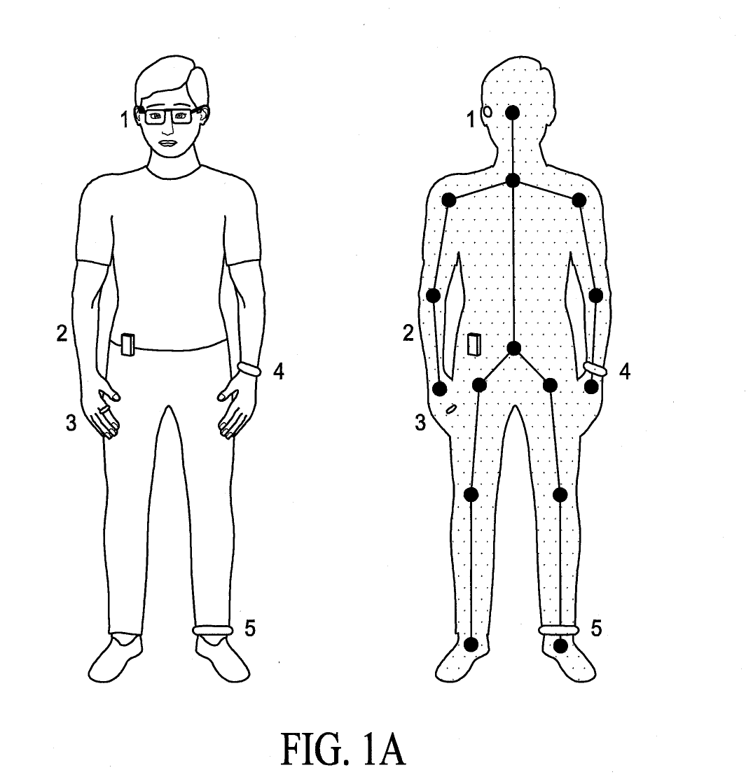

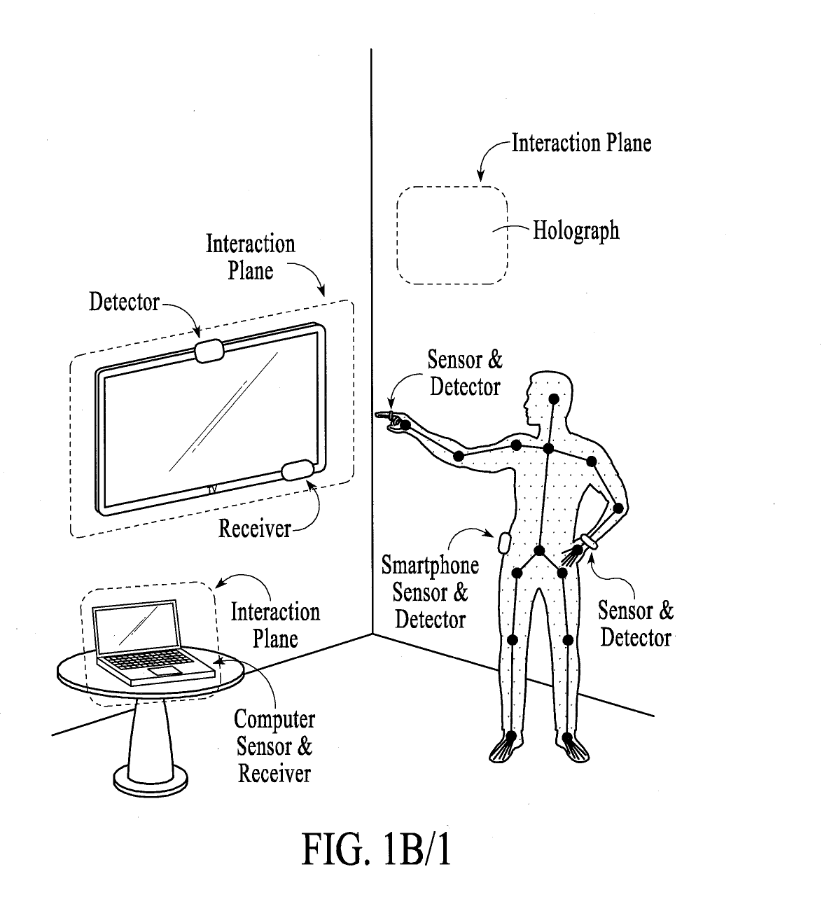

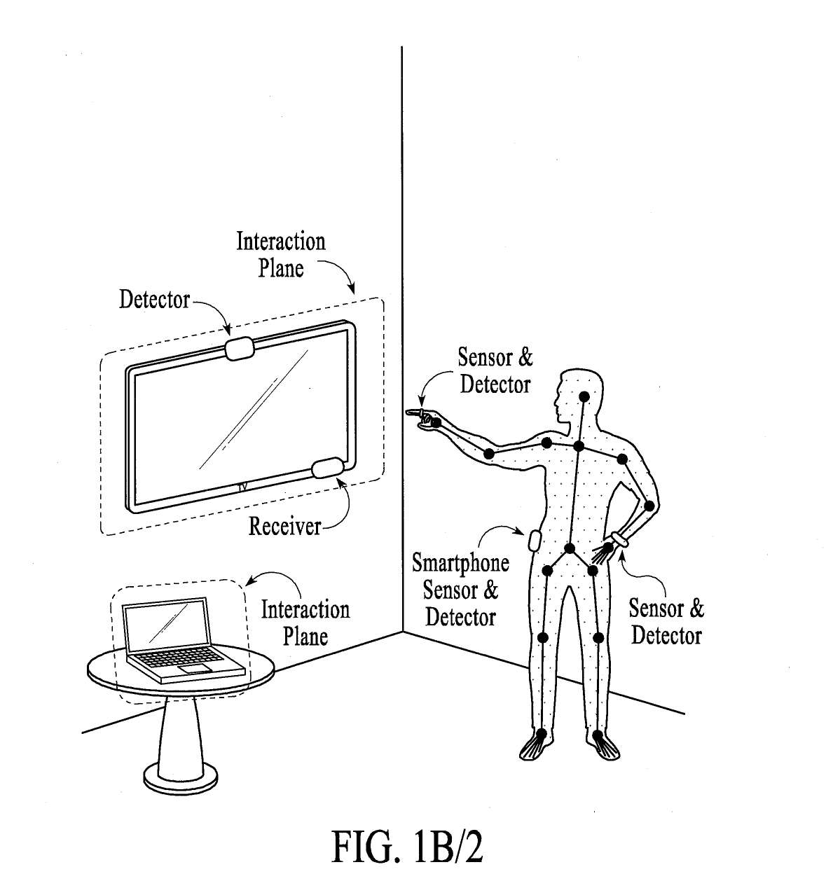

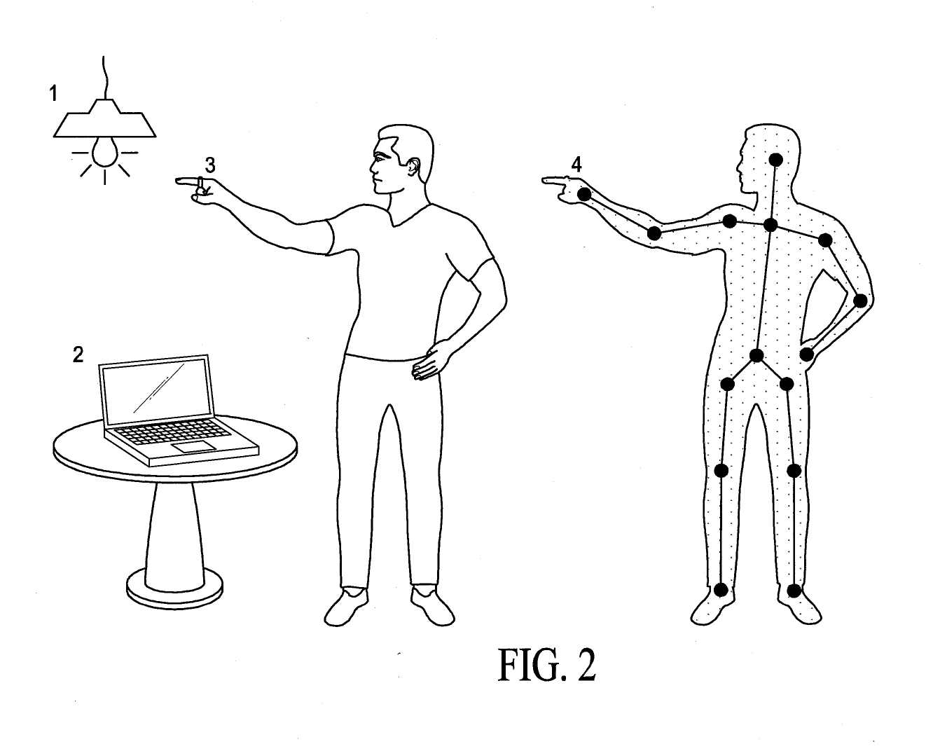

These various aspects are shown in the diagrams attached. FIG. 1(A) illustrates the skeletal rendering of the human with various nodes, and the usage of many different sensors, and specifically on the fingers, hands, wrists and arms of a human as described above. FIGS. 1(B)(1-2) also shows a two different 2D sub-spaces associated with different devices having 2D user interfaces, as well as a 3D holograph subspace FIG. 1(B) illustrates a system diagram with a laptop as one of the devices having 2D user interfaces , but this laptop is shown only as having an interaction plane, and operate upon a distributed system (such as with cloud processing). As is apparent, many different combinations are possible and within the contemplated scope herein.

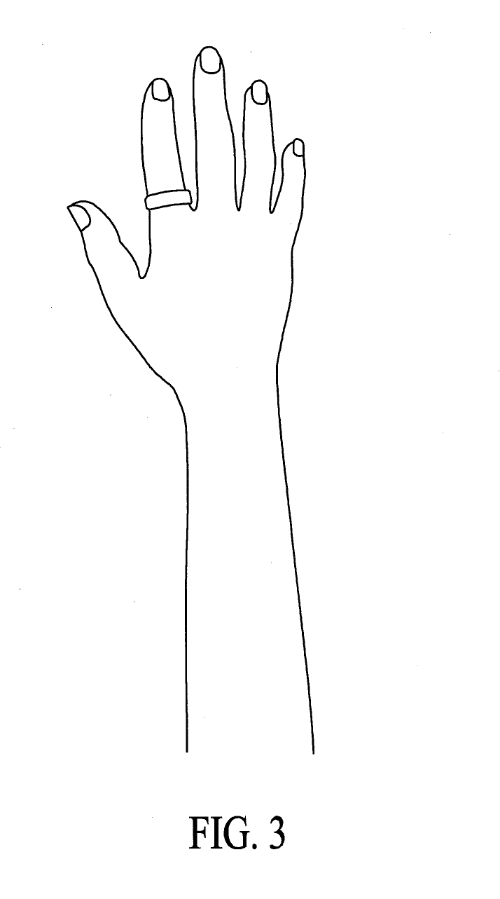

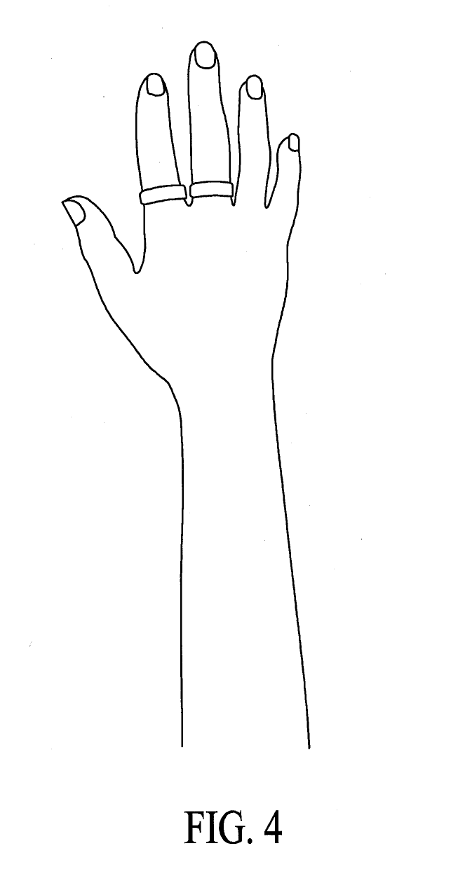

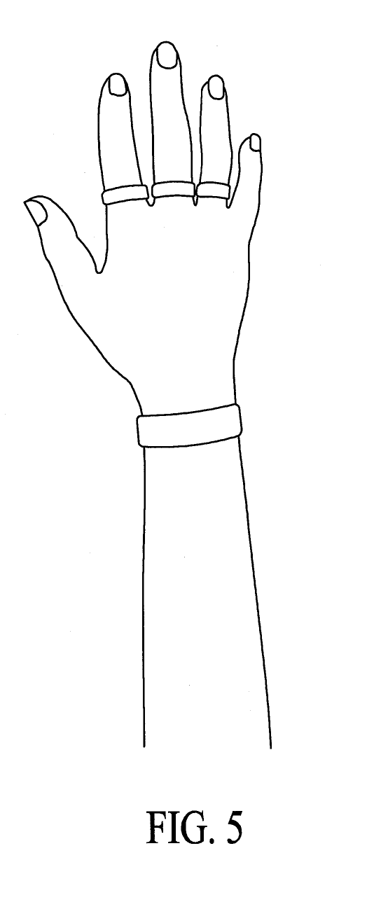

FIGS. 3, 4, and 5 show embodiments for micro-gesture recognition that include usage of 1, 2 and 3 finger rings, respectively, as shown. Other configurations are possible and within the intended scope herein.

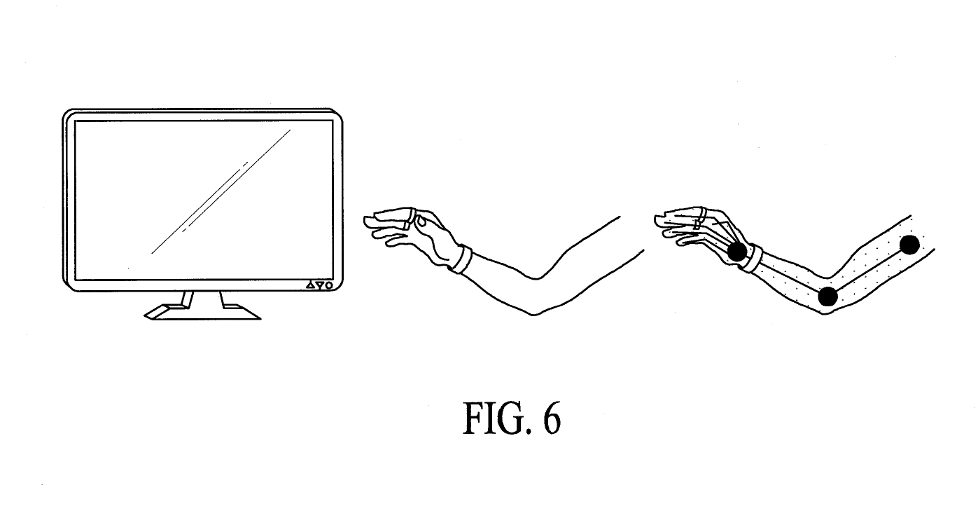

FIG. 6 shows an illustration of micro-gestures that are detected within a subspace around a computer, which sub-space can have its own relative coordinate system, rather than being based upon absolute coordinates. In a particular aspect, the relative coordinate system can also be based upon the sensor locations used for gesture sensing, such as using the elbow to wrist as a primary axis, irrespective of its actual location within the 3D space. In addition to the MEMS sensors in each ring, acceleration can also be used to detect distance from a relative reference point, such as the screen of the computer.

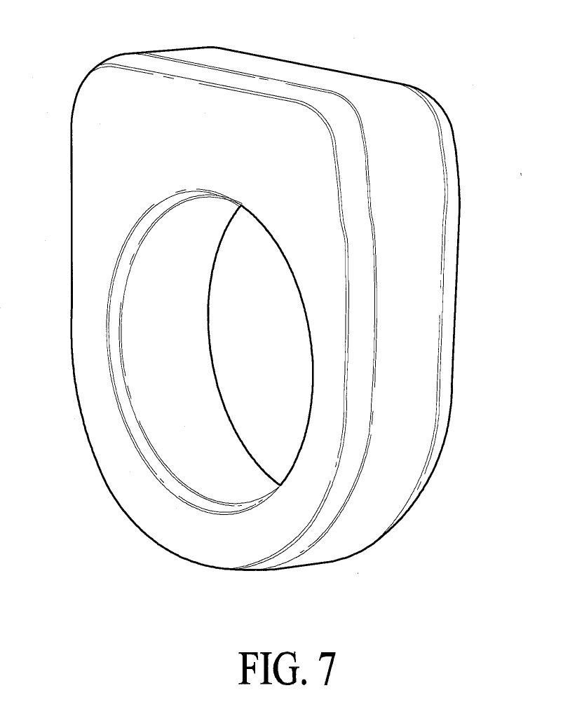

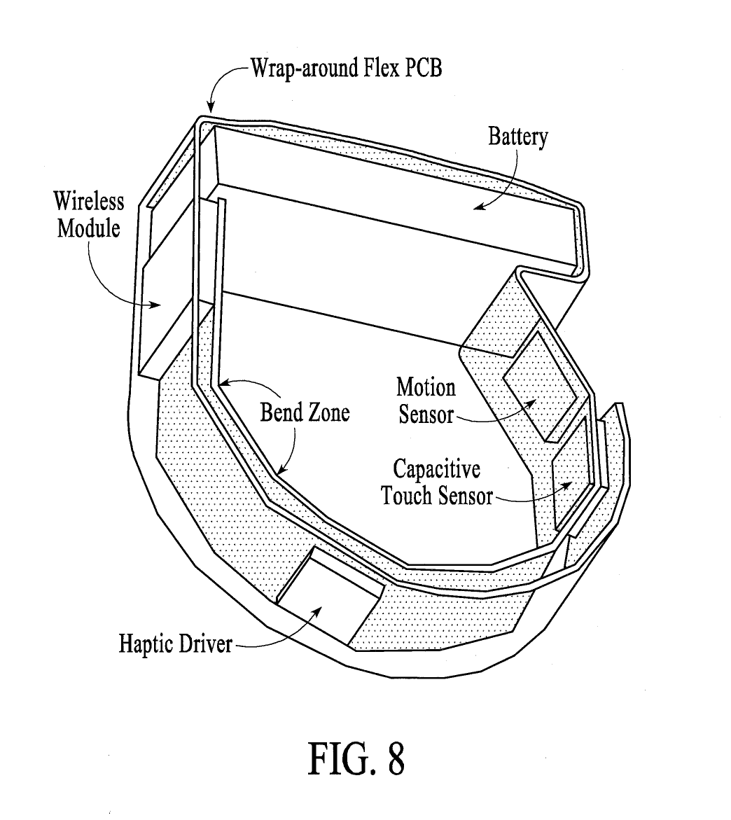

FIG. 7 illustrates a 3D exterior view of a single ring sensor, and FIG. 8 illustrates that ring sensor in a more detailed view, with the significant electronic components identified, and which are connected together electrically as a system using a processor, memory, software as described herein, including other conventional components, for controlling the same, The processor controls the different sensors on the ring device and is in charge of detecting activity in the various sensors, fusing the data in them and sending such data (preferably fused, but in other embodiments not) to other aggregators for further processing. While shown as a ring sensor, this combination of elements can also be used for the other sensors described herein, such as the wrist sensors shown in FIG. 1—though other combinations can also be used.

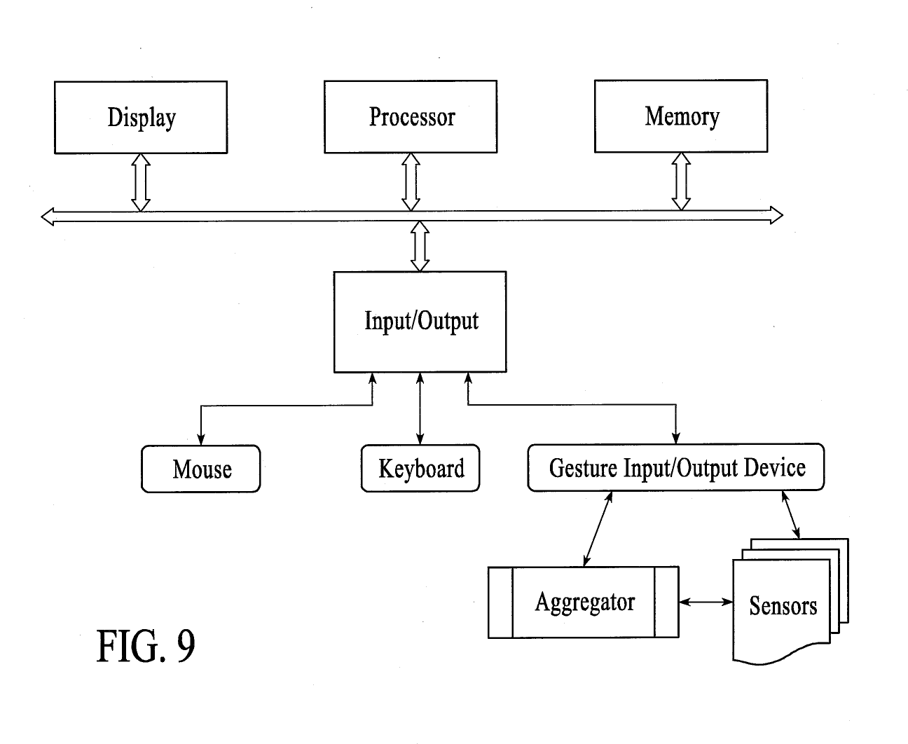

FIG. 9 illustrates a Computer Sensor & Receiver as shown in FIG. 1(B1). As illustrated in FIG. 9, included is a processor, memory and display that are used as is conventionally known. The processor controls the different sensors on the various devices and can fuse the data from disparate devices that has been aggregated previously or not, and send such data (preferably fused, but in other embodiments not) to other aggregators for further processing as well as send control signals based on the what has been detected to control devices such as the light or television as shown in FIG. 1. I/O devices as known are also included, as well as what is labeled a Gesture Input/Output Device and an Aggregator coupled thereto (which Aggregator may be part of the Computer Sensor and Receiver or could be located elsewhere, such as on a wrist sensor as described above). The Aggregator can be implemented in hardware or software to process the various streams of data being received from the various sensors. The Aggregator factors in location of the sensor (e.g: on the finger or wrist etc.) and calculates what data is relevant from this sensor. This is then passed on to the Gesture Input/Output Device (which could also reside across a wireless link) to control various computing devices.

Multiple sensors can efficiently interact with each other providing a stream of individually sensed data. For example a sensor worn on the ring can communicate with a wrist worn device or a smartphone in the pocket. This data could then be aggregated on the smartphone or wrist worn device factoring in the human anatomy. This aggregation may factor in range of motion of the human skeletal joints, possible limitations in the speed human bones could move relative to each other, and the like. These factors, when processed along with other factors such as compass readings, accelerometer and gyroscope data, can produce very accurate recognition of gestures that can be used to interact with various computing devices nearby.

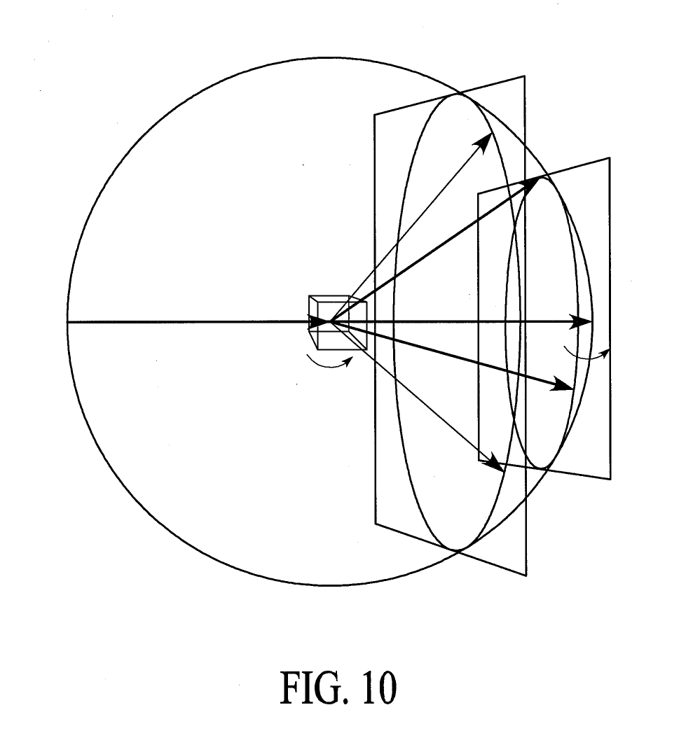

In a particular aspect, as shown in FIG. 10, a 3D space that is bounded by the reach of the human's arm, hands and fingers, is converted into a 2D space. The 3D coordinates within this space are instantaneously converted to 2D using a software application that projects the 3D coordinates onto an imaginary plane, using the system illustrated in FIG. 9. Simultaneously, the coordinates are sized proportional to the dimensions of the plane, i.e., they can be projected onto a small surface such as a smartphone or a large surface such as a television.

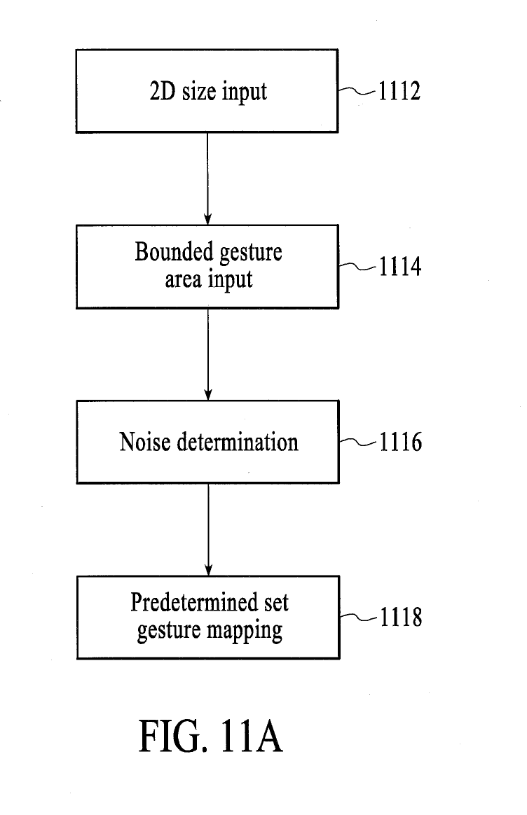

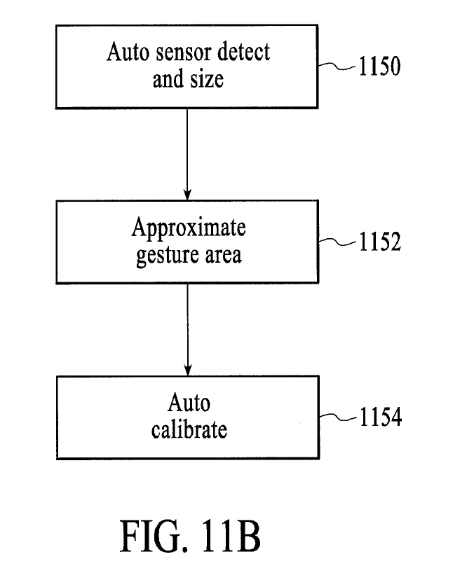

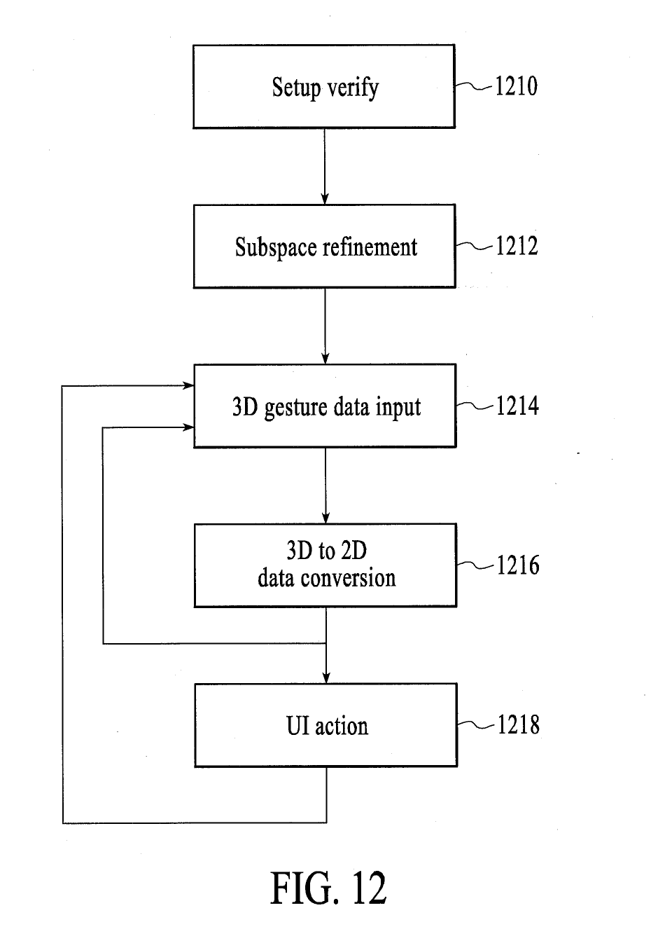

In particular, as shown in the flowcharts of FIGS. 11(a-b) and 12, the following steps are implemented by the software application in which 3D coordinates are instantaneously converted to 2D. In particular, FIG. 11a is directed to one embodiment of a first time set-up of the system, in particular setting-up the initial conditions in which the device will typically operate.

In step 1110 the number of sensors are input. In step 1112, the size of the 2D interface display is input. This can be achieved, for instance, by being pulled directly from a “smart” device or could be defined by the user using some combination of gestures and/or touch (e.g., pointing to the four corners of the screen or tracing the outline of the UI), using a simple L×W input of dimensional input, or in some other manner. In step 1114, the size of the bounded gesture area in input, preferably by the user taking each arm and stretching it up, down, left, right, back and forth, so as to create a 3D subspace, different for each arm/wrist/hand/fingers. In step 1116, the “noise” within the 3D environment is determined in a rough manner, which can then be fine-tuned for various embodiments as described further herein. With respect to the initial determination of noise, the system will account for and remove by filtering out minor tremors in fingers/hands, such as due to a person's pulse or other neurological conditions. In a particular implementation, a minimum threshold for a detectable gesture is defined as used as a reference. Other instances of noise include ambient magnetic fields influencing the magnetometer/compass sensor, resulting in spurious data that is also filtered out. Another significant noise filtering is determining when the user has stopped interacting or sending purposeful gestures. In step 1118, mapping of a set of predetermined gestures may occur, so that the system can learn for that user the typical placement of the user's arm/wrist/hand/fingers for certain predetermined gestures useful for this particular interaction space.

An alternate set-up implementation is shown in the flowchart of FIG. 11(b), where there is no initial set-up required from the perspective of the user. As shown, once each sensor devise is charged, sensors are automatically detected and the 2D display size is detected once a connection is established, in step 1150. Then in step 1152, the gesture area is approximated, which is invisible to the user. For example for a ring sensing device, the possible range of a finger gesture can be approximated (e.g., one can't bend the finger at an unnatural angle). Additionally, the size of the screen can be utilized as feedback to the user indicating that the user is gesturing at an extremity of the screen, thus indicating to re-position their arm/finger for gestural input. Step 1154 follows, in which the single sensing device is calibrated automatically, particularly when the device is not in motion there is then recalibration. It is noted that specific calibration of individual sensor data is not needed in one embodiment, and such sensor data is fused without requiring calibration to determine gestures. it in a way that such calibrations are not necessary

During use, as shown in FIG. 12, initial conditions from the FIG. 11(a-b) set-up are verified in step 1210. In step 1212, a further refinement of the subspace is obtained based on the particular specific usage. In particular, the software can further refine its interpretation of the gesture data by having the user automatically define a size and 3D orientation of the particular sub-space (e.g., an easel tilted at an angle, a horizontal table top or a vertical whiteboard or large television with a touch screen) of the UI plane, based on user's first gestures or other factors, if only a specific sub-space is of interest and the user will use that particular sub-space as a crutch when gesturing (i.e. confining movement by making gestures at the particular user interface, rather than in space and separate from it). With respect to the FIG. 11b embodiment above, it is noted that this further refinement occurs when the user has started engaging with a display device. So when the user is very close to a TV the arms must reach wider to reach the edges of the TV display, whereas if the user is further away a smaller distance is moved for interaction with the same TV display. Using this feature, along with distance measurements that are approximated between different single sensing devices and the display device, the size of an interaction plane is predicted, and then the sensor data is calibrated for that. It is noted that this interaction plane is preferably dynamically updated based on human motion.

In step 1214, gesture data is input, and in step 1216 gesture data is converted to 2D via projection. In step 1218, the now 2D gesture data is interpreted by the software application for implementation of the desired input to the user interface. As shown, steps 1214, 1216 and 1218 are continuously repeated. If sensors detect a purposeful gesture (based on noise-detection/filtering as described herein), the gesture is converted from 3D to 2D and this dta is then sent to the input of the display device with which there is interaction, using, for example, Bluetooth or similar communication channel. This continues for the duration of the interaction and stops/pauses when a “major disturbance” is detected, i.e., user having stopped interacting. It should also be noted that the extent of the gestures that can occur within the gesture space as defined can vary considerably. Certain users, for the same mapping, may confine their gestures to a small area, whereas other users may have large gestures—and in both instances they are indicative of the same movement. The present invention accounts for this during both the set-up as described, as well as by continually monitoring and building a database with respect to a particular user's movements, so as to be able to better track them, over time. For example a user playing around with a device worn as a ring and touching all surfaces periodically will train the algorithm to the touch pattern caused and the device will ignore such touches.

It should also be noted that the software can also have the ability to account for a moving frame of reference. For instance, if the UI is a tablet/mobile phone screen and is held in one's hand and moving with the user, the ring detects that the device (which has a built-in compass or similar sensor) is moving as well and that the user is continuing to interact with it.

These steps shown in FIGS. 11(a-b) and 12 are described in this manner for convenience, and various ones of these steps can be omitted, they can be integrated together, as well as the order changed, while still being within the intended methods and apparatus as described herein. With respect to a Virtual Reality, Augmented Reality or holographic 3D space, the same principles can be applied, though the 3D to 2D conversion is not needed. In such scenarios the user can reach into a virtual reality scene and interact with the elements. Such interactions could also trigger haptic feedback on the device.

In a specific implementation, there is described the specific use case of mapping of a 3D keyboard onto a 2D interface using the principles as described above. As described previously, the user wears an input platform that enables gesture control of remote devices. In this specific instance, the user intends to use a virtual keyboard to enter data on a device such as a tablet, smartphone, computer monitor, etc. In one typical conventional case where there is a representation of a touch-based input on the screen, the user would use a specific gesture or touch input on their wearable input platform to bring up a 2D keyboard on the UI of the display of the conventional touch-based device, though it is noted that It is not necessary for the UI to have a touch-based input. For instance, with a Smart TV, where the user is trying to search for a movie or TV show, the user will still interact remotely, but the screen would pop-up a keyboard image (typically in 2D) on it.

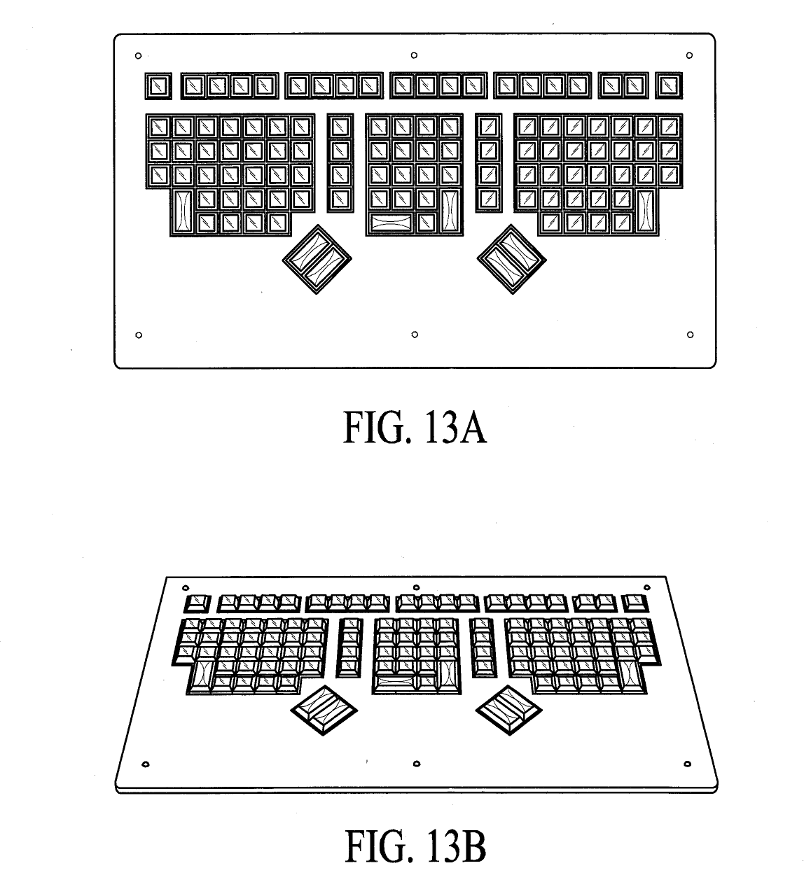

Here, as shown in FIGS. 13a-b, to implement the 3D keyboard, the user uses a modifier key, such as a special gesture indicating a throwback of the keyboard, whereby the special gesture drops the keyboard into perspective view and in a preferred embodiment gives the user a perceived depth to the keyboard with the impression of a 3D physical keyboard, as shown in FIG. 13b. This specific perspective view can then be particularly accounted for in the step 1212 further refinement of the subspace of FIG. 12, where in this instance the subspace is the 3D physical keyboard, and the gesture space of the user specifically includes that depth aspect. As such, the keyboard space can be configured such that the space bar is in the front row of the space, and each of the 4 or five rows behind that are shown as behind in the depth perception. In a particular implementation, a projection of a keyboard can be made upon the special gesture occurring, allowing the use to actually “see” a keyboard and type based on that. Other algorithms such as tracing of letter sequences can also be used to allow for recognition of the sequence of keys that have been virtually pressed.

This enables the user to interact with the 3D keyboard using gestures in 3D in a manner that closely mimics actual typing on a physical keyboard.

In another aspect, there is provided the ability to switch between 2D and 3D virtual keyboards using the specific gesture, such that the user can switch back and forth between the physical touching of the touch-sensitive interface on the display of the device and the 3D virtual keyboard as described, or tracing the outline of a word remotely using gestures as in the case of a smart TV (which does not have a touch-sensitive input).

As will be appreciated, this specific embodiment allows for the use of gestures to closely mimic the familiar sensation of typing on a physical keyboard.

Although the present inventions are described with respect to certain preferred embodiments, modifications thereto will be apparent to those skilled in the art.

1. An apparatus capable of interacting with at least one controllable device based upon a pose of at least a portion of a human body, the apparatus comprising:
one or more sensors that are sized for wearing on the human body, each of the one or more sensors emitting sensor data; and
a detection unit that operates upon the sensor data to determine the pose of at least the portion of the human body within a bounded three dimensional interaction space and is capable of interacting with the at least one controllable device, the detection unit including:
a memory that stores at least one or more characteristics of human anatomy that are associated with the human body using at least a partial skeletal rendering of a human; and
a detection processor, automatically operating under software control, that inputs, aggregates and fuses the sensor data from each of the one or more sensors using the at least one or more characteristics of human anatomy stored in the memory to determine the pose in a two-dimensional space of at least the portion of the human body based upon a locality of said one or more sensors, wherein the gesture processor inputs a set of sensor data limited by the bounded three dimensional interaction space, obtains an initial determination of a three dimensional orientation of the one or more sensors within the bounded three dimensional interaction space, and converts three dimensional coordinates into the two dimensional space;
wherein at least some of the one or more sensors are packaged in an integrated mechanical assembly.

2. The apparatus according to claim 1 wherein the bounded three dimensional interaction space is an arm sized space determined by arm, wrist and finger movement.

3. The apparatus according to claim 2 wherein the bounded arm sized space is further limited to use only portions thereof corresponding to ranges of motion for the arm, wrist and finger movements.

4. The apparatus according to claim 2 wherein the detection unit is also packaged in the integrated mechanical assembly.

5. The apparatus according to claim 1 wherein the bounded three dimensional interaction space is a hand sized space determined by wrist and finger movement.

6. The apparatus according to claim 5 wherein the bounded hand sized space is further limited to use only portions thereof corresponding to ranges of motion for the wrist and finger movements.

7. The apparatus according to claim 5 wherein the detection unit is also packaged in the integrated mechanical assembly.

8. The apparatus according to claim 1 wherein the bounded three dimensional interaction space is an head area space determined by neck and head movement.

9. The apparatus according to claim 8 wherein the bounded arm sized space is further limited to use only portions thereof corresponding to ranges of motion for the neck and head movements.

10. The apparatus according to claim 9 wherein the detection unit is also packaged in the integrated mechanical assembly.

11. The apparatus according to claim 1 wherein a plurality of different bounded three dimensional interaction spaces are aggregated into a complete space.

12. The apparatus according to claim 11 wherein a plurality of integrated mechanical assemblies sized for wearing on the human body and each using one or more sensors are used in obtaining the sensor data used by the detection processor.

13. The apparatus according to claim 11 wherein each of the plurality of different bounded three dimensional interaction spaces are further limited to use only portions thereof corresponding to ranges of motion for corresponding body movements.

14. The apparatus according to claim 1 wherein the detection processor further filters out noise caused by minor tremors or a pulse of the human.

15. The apparatus according to claim 1 wherein the two dimensional space further includes sizing of coordinates proportional to dimensions of the two dimensional space, the dimensions of the two dimensional space determined based upon a screen size.

16. The apparatus according to claim 1 further including a database of a particular user movements over a period of time, wherein the database of the particular user movements is used to determine an initial set-up mapping configuration.

17. A method for interacting with at least one controllable device based upon a pose of at least a portion of a human body, the method comprising:
sensing, using one or more sensors that are sized for wearing on the human body, sensor data from each of the one or more sensors; and
determining the pose in a two-dimensional space of at least the portion of the human body within a bounded three dimensional interaction space based upon the sensor data, under processor and software control, the step of determining operating to:
associate at least one or more characteristics of human anatomy with the human body using at least a partial skeletal rendering of a human; and
automatically determine, under the processor and software control the pose in the two-dimensional space of at least the portion of the human body based upon a locality of said one or more sensors, the step of automatically determining including inputting, aggregating and fusing the sensor data from each of the one or more sensors using the at least one or more characteristics of human anatomy to determine the pose, wherein sensor data input is limited by the bounded three dimensional interaction space, wherein an initial determination of a three dimensional orientation of the one or more sensors is made within the bounded three dimensional interaction space, wherein three dimensional coordinates are converted into the two dimensional space, and wherein the at least one or more characteristics of human anatomy that are associated with the human body that are stored in the memory include at least one of (a) a range of motion of human skeletal joints and (b) limitations in the speed human bones can move relative to each other.

18. The method according to claim 17 wherein the bounded three dimensional interaction space is an arm sized space determined by arm, wrist and finger movement.

19. The method according to claim 18 wherein the bounded arm sized space is further limited to use only portions thereof corresponding to ranges of motion for the arm, wrist and finger movements.

20. The method according to claim 17 wherein the bounded three dimensional interaction space is a hand sized space determined by wrist and finger movement.

21. The method according to claim 20 wherein the bounded hand sized space is further limited to use only portions thereof corresponding to ranges of motion for the wrist and finger movements.

22. The method according to claim 17 wherein the bounded three dimensional interaction space is an head area space determined by neck and head movement.

23. The method according to claim 22 wherein the bounded arm sized space is further limited to use only portions thereof corresponding to ranges of motion for the neck and head movements.

24. The method according to claim 17 wherein a plurality of different bounded three dimensional interaction spaces are aggregated into a complete space.

25. The method according to claim 24 wherein each of the plurality of different bounded three dimensional interaction spaces are further limited to use only portions thereof corresponding to ranges of motion for corresponding body movements.

26. The method according to claim 17 wherein the step of determining the pose includes filtering out noise caused by minor tremors or a pulse of the human.

27. The method according to claim 17 wherein the two dimensional space further includes sizing of coordinates proportional to dimensions of the two dimensional space, the dimensions of the two dimensional space determined based upon a screen size.

28. The method according to claim 17 further including the step of creating a database of a particular user movements over a period of time, wherein the database of the particular user movements is used to determine an initial set-up mapping configuration in the step of determining the pose.
